(19) United States
(12) Patent Application Publication
(10) Pub. No.: US 2013/0001137 A1
(43) Pub. Date: Jan. 3, 2013

(54) NANOPARTICLE FLOTATION COLLECTORS

(75) Inventors: Robert Pelton, Dundas (CA); Songtao Yang, Hamilton (CA)

(73) Assignee: MCMASTER UNIVERSITY, Hamilton, ON (CA)

(21) Appl. No.: 13/575,627

(22) PCT Filed: Jan. 27, 2011
(86) PCT No.: PCT/CA11/00104

§ 371 Date: Sep. 12, 2012

Related U.S. Application Data
(60) Provisional application No. 61/299,173, filed on Jan. 28, 2010.

(51) Int. Cl. B03D 1/002; B03D 1/00; B82Y 30/00

(52) U.S. Cl. 209/4; 977/962

(57) ABSTRACT

The present disclosure relates to a process for collecting a particulate material from a mixture comprising treating the mixture with hydrophobic nanoparticles under conditions to adsorb the hydrophobic nanoparticles to the particulate material and collecting the particulate material by flotation.

### CROSS-REFERENCE TO RELATED APPLICATIONS

The present application claims the benefit of co-pending U.S. provisional patent application No. 61/299,173 filed on Jan. 28, 2010, the contents of which are incorporated herein by reference in their entirety.

### FIELD

The present disclosure relates to processes of collecting particulate materials using flotation. In particular, the present disclosure relates to flotation processes that utilize nanoparticles for the collection of particulate materials, such as minerals.

### BACKGROUND

Flotation is a very important separation process for mineral processing in which air bubbles are passed through an aqueous suspension of mineral particles and unwanted gangue. By selectively manipulating the mineral particle surface properties, it is possible to induce selective attachment of the air bubbles to the particles. The particle laden bubbles rise to the surface and the surface foam phase is separated from the gangue.

In conventional flotation, small hydrophobic molecules, called collectors, are adsorbed onto particle surfaces to selectively, hydrophobically modify these surfaces. Typically, collectors are short alkyl chains (2-6 carbon atoms) terminated by a xanthate or thiocarbonate or other functional group that will chemi-sorb or selectively physically adsorb onto the target particle surface. By lowering the surface energy, the collector facilitates particle adhesion to air bubbles during flotation.

### SUMMARY

In the present disclosure, hydrophobic small molecule collectors have been replaced, or partially replaced, with hydrophobic nanoparticles. Nanoparticles can increase hydrophobicity and introduce nanoscale roughness on particle surfaces. In an embodiment of the disclosure, the hydrophobic nanoparticles bear surface ligand functional groups that bind the nanoparticles to the particulate material to be collected.

Accordingly, the present disclosure includes a process for collecting a particulate material from a mixture comprising treating the mixture with hydrophobic nanoparticles under conditions to adsorb the polymeric nanoparticles to the particulate material and collecting the particulate material by flotation.

In a further embodiment, the process of the disclosure further includes a use of a small molecule collector in combination with the hydrophobic nanoparticles of the present disclosure.

In another embodiment of the disclosure there is included a use of hydrophobic nanoparticles for modifying the surface of a particulate material for flotation-based collection of the particulate material.

Other features and advantages of the present application will become apparent from the following detailed description. It should be understood, however, that the detailed description and the specific examples, while indicating embodiments of the application, are given by way of illustration only, since various changes and modifications within the spirit and scope of the application will become apparent to those skilled in the art from this detailed description.

### DRAWINGS

The application will now be described in greater detail with reference to the drawings in which:

FIG. 1 is a schematic drawing of a flotation apparatus.

FIG. 2 is a graph showing particle size distribution of the glass beads employed in an example of the disclosure.

FIG. 3 is a graph showing electrophoretic mobility of the unwashed glass beads as a function of pH in an example of the disclosure.

FIG. 4 is a graph showing electrophoretic mobility of three polystyrene (PS) nanoparticles used to decorate glass beads as a function of pH in an example of the disclosure.

FIG. 5 is a graph showing advancing and receding contact angle (CA) of three films formed by the drying of 0.1 mL of the three PS nanoparticles on 1 cm² glass substrate using sessile drop and air bubble captive methods in an example of the disclosure.

FIG. 6 is a graph showing flotation results of glass beads (the total mass for each run was 2 g) in 5 mM NaCl in an example of the disclosure. Cumulative weight of collected beads versus the volume of collected liquors for no PS addition (47.8% yield), addition of St-01-357 nm nanoparticle (excess PS nanoparticle additions amount 1.0 mL of 27.15 g/L, λ=237.5%): conditioned 5 min (67.7% yield), 30 min (92.3% yield), 90 min (98.6% yield), respectively.

FIG. 7 shows SEM images of ST-01-357 nm PS colloidal particles deposited onto the surface of glass beads in 5 mM NaCl (excess PS amount, λ=227.5%) (a) taken from flotation mixture when conditioned at 5 min interval that lead to lower PS coverage, and (b) when conditioned at 30 min interval that lead to higher PS coverage.

FIG. 8 is a graph showing flotation results of glass beads (the total mass of each run was 2 g) in 5 mM NaCl in an example of the disclosure. Cumulative weight of collected beads versus the volume of collect liquors with different PS nanoparticle concentration (0.1 mL, 0.2 mL, 0.5 mL, 0.7 mL and 1,0 mL of 27.15 g/L St-01; λ=22.75%, 45.50%, 113.8%, 159.3% and 227.5%, respectively) when conditioned for 30 min.

FIG. 9 is a graph showing the flotation recovery of glass beads as a function of fixed St-MAPTAC-03 coverage ratios. The added St-MAPTAC-03 amount was 0, 0.05, 0.1, 0.3, 0.5, 0.7 and 1.0 mL of a St-MAPTAC-03 dispersion having a concentration of 18.55 g/mL.

FIG. 10 shows SEM images of dry glass beads covered by fixed PS coverage after flotation; (a) no St-MAPTAC-03 y=39.8%, (b) 0.05 mL St-MAPTAC-03 y=56.5%, (c) 1 mL St-MAPTAC-03 y=97.0%, and (d) 1 mL St-MAPTAC-03 y=97.0%.

FIG. 11 is a graph showing flotation results of glass beads (the total mass for each run was 2 g) in 5 mM NaCl. Cumulative weight of collected beads versus the volume of collect liquors for different excess amounts of PS nanoparticle (St-01, 357 nm, λ=227.5%; St-MAPTAC-03, 78.8 nm, λ=213.4%, respectively) when conditioned for 60 min.

FIG. 12 is a graph showing flotation results of glass beads (the total mass for each run was 2 g) in 5 mM NaCl. Cumulative weight of collected beads versus the volume of collect liquors for adding different excess amounts of PS nanoparticles (St-MAPTAC-03-78.8 nm, St-01-357 nm, St-01-678 nm, and St-01-2227 nm) when conditioned for 5 min.

FIG. 13 is a graph showing flotation results of glass beads (the total mass for each run was 2 g) in 5 mM NaCl. Cumulative weight of collected beads versus the volume of collect liquors for different excess amounts of PS nanoparticles (St-01, positively charged, λ=227.5%; St-02, negatively charged, λ=309.6%, respectively) when conditioned for 30 min.

FIG. 14 is a graph showing the electrophoretic mobility of St-VI-MAPTAC/St-MAPTAC nanoparticles prepared in the examples of the disclosure as a function of pH.

FIG. 15 is a graph showing the particle size distribution of the Pentlandite (Pn), glass beads and Tails suspensions used in the examples of the disclosure. The d(0.5) values are the volume weighted means.

FIG. 16 is a graph showing electrophoretic mobility of the Pn, glass beads and tails used in the examples of the disclosure as a function of pH.

FIG. 17 is a graph showing the adsorbed amount of Ni²⁺ onto St-VI-MAPTAC-3/St-MAPTAC-1 nanoparticles as a function of initial Ni²⁺ concentration. Initial concentrations of NiSO₄ were 5×10⁻⁴ M, 1×10⁻³ M, 2×10⁻³ M and 3×10⁻³ M, corresponding to 29.4, 58.7, 117.4, and 176.1 ppm of nickel. 0.5 mL of 33.3 g/L St-VI-MAPTAC-3 were compared with 0.92 mL of 18.2 g/L St-MAPTAC-1 when interacted with 40 mL of the Ni²⁺ solutions.

FIG. 18 is a graph showing Pn recovery versus the cumulative volume of collected liquid. Runs were either in 5 mM NaCl (pH =6.7±0.4) or in 5 mM Na₂CO₃ (pH=10.6±0.3). The nanoparticle dosages for St-MAPTAC-1 (1.0mL of 18.2 g/L) and St-VI-MAPTAC-2 (0.5mL of 24.2 g/L) were in excess of the amounts required to completely cover the Pn surfaces (i.e. λ_{T}>100%).

FIG. 19 are graphs showing the results of the flotation a mixture of washed Pn and glass beads in 5 mM NaCl in the presence of St-MAPTAC-1 (1.0mL of 18.2 g/L, I_{T}=382%) or St-VI-MAPTAC-2 (0.5 mL of 24.2 g/L, I_{T}=295%). The nanoparticles containing imidazole surface groups were more effective.

FIG. 20 is a graph showing flotation results for mixtures of pentlandite and Tails suspended in 5 mM Na₂CO₃ (pH=10.6±0.3) plus 10 mg/L UNIFROTH 250C, for St-VI-MAPTACs compared with potassium amyl xanthate (PAX).

FIG. 21 shows SEM images of dry samples collected from recovered mixtures of pentlandite and tails (MgO rich slime materials, marked as slime in the images) after each flotation run in 5 mM Na₂CO₃ using St-VI-MAPTAC-3 nanoparticles as collectors a. & b. Pn covered by plenty of St-VI-MAPTAC-3, image b. is focused on from side view of a part of Pn (diagonal line in the image is focused); c. & d. Tails adsorbed by very few St-VI-MATPAC-3, a piece of slime focused on in image d. is marked in a rectangle. All of scale bars in the images are 1 μm.

FIG. 22 is a graph showing flotation of glass beads with different types of precipitated calcium carbonate.

### DETAILED DESCRIPTION

### (i) Definitions

Unless otherwise indicated, the definitions and embodiments described in this and other sections are intended to be applicable to all embodiments and aspects of the disclosure herein described for which they are suitable as would be understood by a person skilled in the art.

As used in this application, the singular forms “a”, “an” and “the” include plural references unless the content clearly dictates otherwise. For example, an embodiment including “a particulate material” should be understood to present certain aspects with one type of particulate material, or two or more additional types of particulate materials.

In embodiments comprising an “additional” or “second” component or “type”, the second component as used herein is chemically different from the other components or first component. A “third” component is different from the other, first, and second components, and further enumerated or “additional” components are similarly different.

The term “suitable” as used herein means that the selection of the particular conditions would depend on the specific method to be performed, but the selection would be well within the skill of a person trained in the art.

In understanding the scope of the present disclosure, the term “comprising” and its derivatives, as used herein, are intended to be open ended terms that specify the presence of the stated features, elements, components, groups, integers, and/or steps, but do not exclude the presence of other unstated features, elements, components, groups, integers and/or steps. The foregoing also applies to words having similar meanings such as the terms, “including”, “having” and their derivatives. The term “consisting” and its derivatives, as used herein, are intended to be closed terms that specify the presence of the stated features, elements, components, groups, integers, and/or steps, but exclude the presence of other unstated features, elements, components, groups, integers and/or steps. The term “consisting essentially of”, as used herein, is intended to specify the presence of the stated features, elements, components, groups, integers, and/or steps as well as those that do not materially affect the basic and novel characteristic(s) of features, elements, components, groups, integers, and/or steps.

Terms of degree such as “substantially”, “about” and “approximately” as used herein mean a reasonable amount of deviation of the modified term such that the end result is not significantly changed. These terms of degree should be construed as including a deviation of at least ±5% of the modified term if this deviation would not negate the meaning of the word it modifies.

The term “mineral” as used herein refers to any element or chemical compound that is normally crystalline and that has been formed as a result of geological processes.

The term “tailings” refers to the materials left over after the process of separating the valuable fraction from the uneconomic fraction (gangue) of an ore. Tailings are also referred to as slimes, tails, leach residue or slickens.

The term “hydrophobic” as used herein refers to a substance that possesses the characteristic that its surface gives a finite contact angle with water. Hydrophobic substances are typically non-polar and are substantially insoluble in water.

The term “ore” as used herein refers to a type of geological material that can be isolated by mining and that comprises at least one mineral.

### (ii) Processes of the Disclosure

It has been shown herein that hydrophobic nanoparticles, such as polystyrene (PS) nanoparticles and hydrophobic calcium carbonate nanoparticles, can be used in flotation processes to collect and recover particulate materials from mixtures. In the examples disclosed herein, PS and fatty acid-coated calcium carbonate nanoparticles were shown to effectively adsorb to silica- and nickel-based materials through both electrostatic- and complexation-based interactions, and these nanoparticle-coated materials were collected using standard flotation procedures. A direct comparison between the functionalized PS nanoparticles of the present disclosure and the typical pentlandite (Pn) collector, potassium amyl xanthate (PAX), was made for the collection of Pn from a mixture of pentlandite and tailings, and the nanoparticles were shown to provide superior results. Therefore the present disclosure includes flotation collectors based on hydrophobic nanoparticles that can partially or fully replace small molecule collectors in, for example, mineral separation processes.

Included as an aspect of the present disclosure is a process for collecting a particulate material from a mixture comprising treating the mixture with hydrophobic nanoparticles under conditions to adsorb the hydrophobic nanoparticles to the particulate material and collecting the particulate material by flotation.

In an embodiment of the disclosure, the hydrophobic nanoparticles comprise any hydrophobic water insoluble material. In a further embodiment, the hydrophobic nanoparticles comprise, consist of, or consist essentially of polymeric nanoparticles or inorganic nanoparticles. Examples of polymeric nanoparticles include, but are not limited to, nanoparticles prepared from polymers and co-polymers based on vinyl monomers, such as polystyrene, poly(methyl methylacrylate), polyethylene, polypropylene, polybutadiene, polyvinylchloride, polyvinylacetate and polyacrylonitrile, fluorochemical polymers and copolymers, such as polytetrafluoroethylene, polychlorotrifluoroethylene, copolymer of tetrafluoroethylene and perfluoroalkylvinylether, copolymer of tetrafluoroethylene and hexafluoropropylene and copolymer of tetrafluoroethylene and polyvinylidene fluoridethylene, and condensation polymers, such as crosslinked silicones, polyesters and polyamides. Examples of polyesters include, polyglycolic acid, polylactic acid, polycaprolactone, polyethylene adipate, polyethylene terephthalate, polybutylene terephthalate, polytrimethylene terephthalate, and polyethylene naphthalate.

In an embodiment of the disclosure, the hydrophobic polymeric nanoparticles comprise, consist of, or consist essentially of a hydrophobic water insoluble material based on polystyrene (PS).

In a further embodiment of the disclosure, the hydrophobic nanoparticles are inorganic nanoparticles including, for example, nanoparticles prepared from silica, calcium carbonate, aluminum silicates, aluminates or titanium dioxide, or the like. In another embodiment, the hydrophobic nanoparticles comprise inorganic nanoparticles prepared from calcium carbonate. To increase their hydrophobicity, the inorganic nanoparticles, if required, are coated with a hydrophobic substance, such as a fatty acid.

In a further embodiment the hydrophobic nanoparticles comprise a means for adsorbing the nanoparticles to the particulate material. This means can be based on any attraction or binding method known in the art, or combinations thereof, for example, electrostatic interactions, antibody-antigen interactions, complexation, biotin-streptavidin interaction, and chemical bond formation between compatible functional groups, for example, cis-diol borate coupling (see U.S. Pat. No. 7,399,645), and azide-alkene Huisgen cycloaddition coupling (or other chemistries that have been collectively referred to as “Click chemistry, see: H. C. Kolb, M. G. Finn and K. B. Sharpless (2001). “Click Chemistry: Diverse Chemical Function from a Few Good Reactions” Angewandte Chemie International Edition, 40 (11): 2004-2021).

In an embodiment, the means for adsorbing the nanoparticles to the particulate material to be collected comprises electrostatic interactions, i.e. the nanoparticles comprise either a net positive or negative charge, depending on the charge of the particulate material to be collected. Therefore, positively charged nanoparticles can be used to adsorb, and therefore collect, negatively charged particulate material, and vice versa. The charge of a nanoparticle or particulate material can be determined, for example, using electrophoretic mobility measurements at a specified pH.

In a further embodiment, the means for adsorbing the nanoparticles comprises complexation. In this embodiment, the hydrophobic nanoparticles are modified to include a functional group that forms complexes with the particulate material to be collected. Such functional groups may be incorporated into the nanoparticles using any known method, for example, by co-polymerization with an appropriate monomer or by post-functionalization of the pre-made nanoparticle. Examples of suitable functional groups will depend on the identity of the particulate material to be collected, as would be known to a person skilled in the art, but include, carboxyl groups, sulfate groups, phosphate groups, primary amines, secondary amines, tertiary amines, quaternary amines, imidazole groups, oxime groups, histidine groups, thiourea groups, hydroxyquinoline groups, xanathate groups, and the like, and combinations thereof. In an embodiment, the functional groups are covalently bonded to the nanoparticle by a chemical linker so that the group extends beyond the surface of the nanoparticle for attachment to the particulate material. Such linkers may be based on, for example, alkylene groups (i.e. —(CH₂)ₘ—, m=1-20, 1-10, or 1-4), optionally interrupted by one or more alkenylene, phenyl, pyridyl, ether, thioether, amine, ester, amide, urethane, carbonate and/or urea groups. As a representative, non-limiting example, when the particulate material is a mineral, such as pentlandite, the complexation functional group can be imidazole and/or a quaternary amine. Methods of preparing functionalized polymeric nanoparticles are known to those skilled in the art (see, for example, Gilbert, R. G., Emulsion

Polymerization A Mechanistic Approach. Academic Press: London, 1995; p 362; Buscall, R.; Corner, T.; Stageman, J. F., Polymer Colloids. Elsevier: London, 1985). For example, imidazole groups are introduced into vinyl polymers by including vinylimidazole as a monomer in the polymerization reaction and quaternary amines are introduced into vinyl polymers by including a vinyl ammonium chloride (such as 3-methacryloylamino)propyl trimethylammonium chloride) as a monomer in the polymerization reaction.

In an embodiment the nanoparticles comprise a combination of means for adsorbing the nanoparticles to the particulate material to be collected, for example, electrostatic interactions and complexation.

It is an embodiment of the present disclosure that the hydrophobic nanoparticles have a diameter of about 10 nm to about 2000 nm, or about 50 nm to about 500 nm.

In a further embodiment of the present disclosure, the surface of the particulate material is partially or completely coated with the hydrophobic nanoparticles.

In an embodiment of the present disclosure, the particulate material is any mineral that is isolable using flotation methods including, for example, sulfide minerals, nonsulfide minerals, and precious metals. Accordingly, the mixture is for example a mineral ore or a precious metal ore. In an embodiment, the particulate material comprises nickel, copper, gold, platinum, palladium, bismuth, molybdenum, arsenic, uranium, lead, zinc, tin, iron, phosphates, potash, coal, silicates, sulfates, oxides and salts, and combinations thereof. In a further embodiment, the particulate material is selected from silicates, pentlandite, copper sulfides, chalcopyrite, chalcocite and malachite and mixtures thereof. In a further embodiment, the particulate material is pentlandite.

In an embodiment of the disclosure, the conditions to adsorb the hydrophobic nanoparticles to the particulate material comprise combining the mixture comprising the particulate material with a solution comprising the hydrophobic nanoparticles for a time sufficient for the nanoparticles to adsorb to the particulate material. In an embodiment, this time is called the conditioning time. In a further embodiment, the conditioning time is from about 0.5 min to about 24 h, about 1 min to about 12 h, about 2 min to about 6 h, about 3 min to about 3 hour, about 4 min to about 2 h, or about 5 min to about 1.5 h. In a further embodiment the particulate material and hydrophobic nanoparticles are combined in a neutral (e.g NaCl) or basic (Na₂CO₃) solution, for example, a 5 mM NaCl or 5 mM Na₂CO₃. As would be known to a person skilled, the pH of the solution is adjusted to optimize the means for adsorbing the nanoparticles to the particulate material. A person skilled in the art would further appreciate that the amount of nanoparticles to be used will depend on the identity of the particulate material to be collected, the nanoparticle and the mixture, however this skilled person could determine the amount, in particular with an aim to optimize yields of the particulate material while minimizing costs.

In a further embodiment, the process of the disclosure further includes the use of a small molecule collector in combination with the hydrophobic nanoparticles of the present disclosure.

After conditioning, the particulate material is collected by flotation. In a typical process, a frothing agent is added to, and combined with, the combination of the particulate material and the hydrophobic nanoparticles. Any suitable frothing agent can be used. Following the addition of the frothing agent, an inert gas, such as nitrogen or air, is passed through the combination to generate bubbles, and the particulate material with nanoparticles adsorbed partially or completely thereon, bind to the bubbles and are carried to the surface where they can be collected. As previously noted, methods of collecting particulate materials using flotation are well known in the art, accordingly any known flotation method or apparatus can be used in the process of the present disclosure (see, for example: Fuerstenau, M.; Jameson, G.; Yoon, R., Froth flotation: a century of innovation. Society for Mining, Metallurgy, and Exploration: Littleton, Colo., 2007)

Also included in the present disclosure is a use of hydrophobic nanoparticles for modifying the surface of a particulate material for flotation-based collection of the particulate material.

### EXAMPLES

The following Examples are set forth to aid in the understanding of the invention, and are not intended and should not be construed to limit in any way the invention set forth in the claims which follow thereafter.

### Materials

Styrene (St, 99%, Sigma-Aldrich) and 1-vinylimidazole (VI, ≧99%, Sigma-Aldrich) were purified by vacuum distillation. (3-(Methacryloylamino) propyl) trimethyl ammonium chloride (MAPTAC, 50 wt. % in H₂O, Sigma-Aldrich) was passed through an inhibitor-removing column. 2,2′-Azobis (2-methylpropionamidine) dihydrochloride (V50, 97%), ammonium persulfate (APS, 99%), nickel sulfate (anhydrous, 99.99% trace metals basis), Na₂S.9H₂O (≧98%) and unwashed glass beads (≦106 μm, −140 U.S. sieve) were all purchased from Sigma-Aldrich and used as received. Pentlandite (Pn, ≧70% in purity), tails (MgO rich slime materials), potassium amyl xanthate (PAX) and UNIFROTH™ 250C (99%) were donated by Vale Technical Services Limited Company (Vale, Mississauga, ON). To remove residue PAX and potential oxidation products from surfaces, pentlandite and tails were cleaned according to procedures provided by Vale. Surfactant-free amidine white polystyrene latex (760 nm and 2600 nm, 4% percent solids) was purchased from Interfacial Dynamics Corporation (IDC, Eugene, Oreg.). Methyl isobutyl carbinol (MIBC, 99%) and Unifroth 250C (99%) were donated by Vale Inco Technical Services Limited Company (Mississauga, ON). All water used in the synthesis, characterization and flotation experiments was Milli-Q grade.

The size distribution of employed unwashed glass beads were characterized by Malvern Mastersizer 2000 (MA).

### Example 1

### Non-Functionalized Nanoparticle Preparation And Characterization

Polystyrene (PS) nanoparticles were prepared by the classic emulsifier-free polymerization (Goodwin, J. W., Ottewill, R. H. and Pelton, R.

Studies on the preparation and characterization of monodisperse polystyrene vatices V: The preparation of cationic lattices. Colloid Polym. Sci. 1979, 257, 61-69). The reaction was conducted in a 250 mL three-necked flask equipped with a condenser, a rubber stopper connected to N₂ gas needle purging in and a magnetic stirring bar according to the recipes in Table 1. The N₂ gas was bubbled into 100 mL of water to remove oxygen from the system. After nitrogen purging for half an hour, 5 g styrene and 0.5 g 50 wt. % MAPTAC, if employed, was added into the flask at 70° C. under 350 rpm stirring. The mixtures were conditioned for 10 minutes before 60 mg V50 or 200 mg APS dissolved in 10 mL of water were injected to initiate the polymerization. The reaction was carried out for 24 hours. The final PS nanoparticle was dialyzed for at least 3 days with Milli-Q water before used in flotation experiments. The hydrodynamic diameters of prepared PS nanoparticle were determined by dynamic light scattering (DLS, Brookhaven Instruments Corp.) using a detector angle of 90°. A CONTIN statistical method was used to calculate the particle size distributions. All PS nanoparticles prepared in this study were considered monodisperse, which was evaluated by the polydispersity (poly) value (the measure of particle size distribution width, effective when poly <0.3, the smaller poly the more highly monodisperse). Electrophoretic mobility (EM) measurements were performed using a Zeta PALS instrument (Brookhaven Instruments Corp.) at 25° C. in phase analysis light scattering mode. The reported EM values were the average of 10 runs with each consisting of 15 scans. Samples for both DLS and EM measurements were prepared in clean vials by dispersing a small quantity of PS nanoparticles, after dialyzing, in 5×10⁻³ M NaCl. Sample pH values were adjusted using 0.1 M or 1M HCl and NaOH.

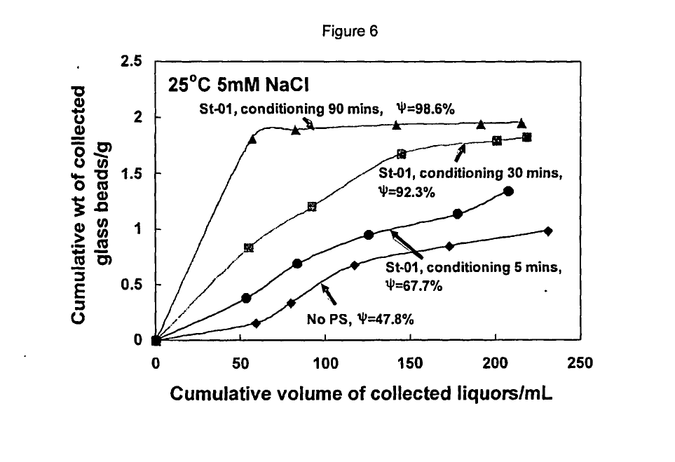

The properties of surfactant-free amidine white polystyrene latex purchased from IDC (760 nm and 2600 nm) were also characterized by DLS and EM measurements and data is presented in Table 2 and FIG. 6.

To measure hydrophobicity of the PS nanoparticles, both sessile drop advancing water contact angle (CA) measurements and underwater air bubble captive receding CA measurements were performed by a Kruss DSA Contact Angle Apparatus and a Rame Hart NRL C.A. Goniometer (Mountain Lakes, N.J.). Samples were prepared by spreading 0.1 mL of 0.25 g/L PS nanoparticle suspension in 2×10⁻³ M NaCl onto 1 cm² glass substrates to form particle films after overnight drying. A drop volume of approximately 0.02 mL of Milli-Q water was used for sessile drop method. The advancing CA results were the average of three measurements recorded in first 20 seconds by DSA 1.80.0.2 software analyzer. The receding CA measurements by the underwater air bubble captive method were performed in 5×10⁻³ M NaCl. An air bubble was placed at the down side of the formed PS nanoparticle film and the CA was recorded by reading from an inside angle meter with the background of green light source. The receding CA results were the average of three reads by changing three air bubbles at different positions of the PS nanoparticle films.

SEM observations of the PS nanoparticle interaction with glass beads at different conditioning periods were performed with a JEOL JSM-7000F scanning electron microscope. Samples were taken from flotation mixtures (excess PS nanoparticle addition amount) at different conditioning intervals. Dry samples taken after flotation were also performed by SEM to observe the morphology of the rough PS nanoparticle coverage ratios resulting in different recovery of glass beads.

### Example 2

### Flotation Experiments With Glass Beads And PS Nanoparticles

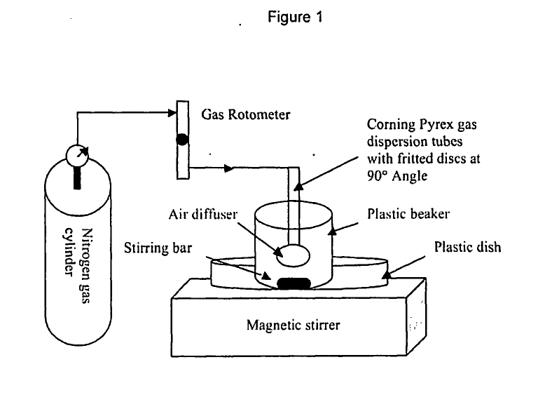

In a typical glass beads flotation experiment, 2 g glass beads and 1 mL of PS nanoparticle (27.15 g/L for St-01) were added into 120 mL of 5×10⁻³M NaCl in a 150 mL plastic flotation beaker (see FIG. 1). The suspension of glass beads and polystyrene nanoparticles was mixed (conditioned) for 5 minutes to permit the polystyrene nanoparticles to deposit onto the glass beads. Following conditioning 0.12 mL 1% Unifroth 250c solution (10 ppm) was added and mixed for 5 more minutes. Flotation was commenced by initiating nitrogen flow at a rate of 2.0 L/min through a Corning Pyrex gas dispersion tube with a 30 mm coarse glass frit attached by a 90 degrees elbow. The foam phase was scraped over the edge of the beaker and captured in the plastic dish (see FIG. 1). After 1.0 min the gas flow was stopped and the plastic collection dish was replaced with a clean dish and the liquid level in the flotation beaker was topped up with NaCl and Unifroth 250c solution at the original concentration. This sequence was repeated until 4˜5 dishes were collected.

Flotation experiments of glass beads with fixed PS nanoparticle coverage glass beads deposited by fixed PS nanoparticle coverage ratios were realized by the method of filtration of the mixtures of PS latex with different concentration and glass beads at fixed conditioning time. After filtration, the glass beads covered by different PS coverage ratios were re-dispersed into the 150 mL plastic flotation beaker with 120 mL of 5×10⁻³M NaCl. Following re-dispersing 0.12 mL of 1% Unifroth 250c solution was added, and then the flotation procedure as described above was repeated.

The mass of liquid plus beads in each dish was measured and the mass of beads was determined gravimetrically after filtration. Typically the amount of liquid collected in each dish was ˜40 g. Flotation results were expressed by plots of the cumulative weight of recovered beads versus the volume of collected liquor. The glass bead recovery (Ψ) was calculated as the mass fraction of the total recovered beads to the total mass of beads (2 g).

The quantity of added polystyrene was expressed as the ratio λ which is equal to:

$$\frac{Total projected area of PS latex}{Total surface area of glass beads}$$

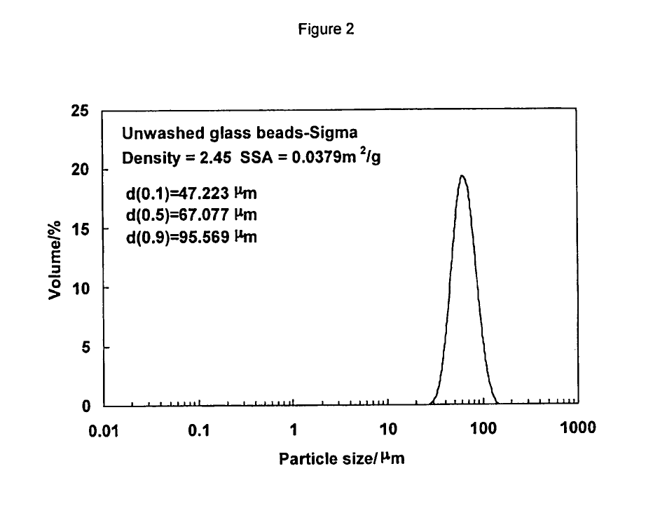

The volume-based particle size distribution results of the glass beads is shown in FIG. 2. d(0.1), d(0.5) and d(0.9) are standard “percentile” readings from the analysis. i.e. d(0.1)=47.223 μm is the size of particle below which 10% of the glass beads lies; d(0.5)=67.077 μm is the size in microns at which 50% of the glass beads is smaller and 50% is larger, and this value is also known as the volume median diameter, which is the value used to do calculations in the following parts; d(0.9)=95.569 μm gives a size of particle below which 90% of the glass beads lies. The span of the distribution is calculated as [d(0.9)−d(0.1)]/d(0.5)=0.72, which is relatively small, meaning the size distribution is relatively narrow. Specific surface area (SSA) is defined as the total area of the glass beads divided by the total weight. To calculate the SSA the density of the glass beads must be known. Herein, the density of glass beads used was 2.45 g/cm³, which provided a SSA of glass beads equal to 0.0379 m²/g.

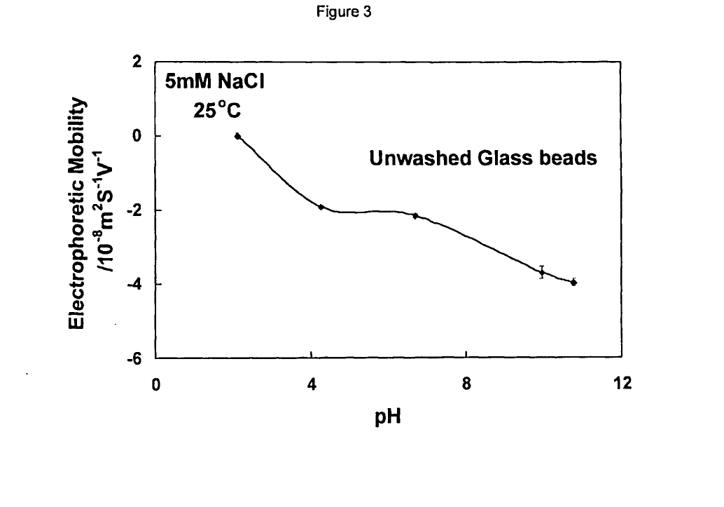

FIG. 3 shows the electrophoretic mobility of the employed glass beads as a function of pH. Under conditions of the flotation experiments, 5×10⁻³M NaCl (pH=6.7±0.4), the beads were negatively charged with the mobility about −2.0.

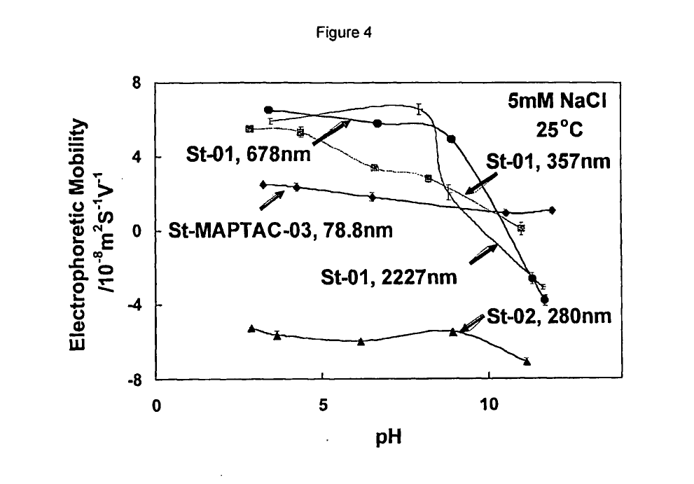

The EM measurements of the three types of PS nanoparticles (See Tables 1 and 2) as a function of pH are shown in FIG. 4. There are three different particle sizes of type St-01, namely, 357 nm, 678 nm, and 2227 nm, respectively. St-01 is the cationic polystyrene colloidal particles initiated by V50 from monomer styrene. The cationic charges of St-01 were amidine groups that display pH dependent degree of ionization. By contrast, the surface cationic charges on St-MAPTAC-03 mainly came from the quaternary ammonium of MAPTAC, so the mobility of it was almost independent of pH. St-02 is PS nanoparticle initiated by APS, which is negatively charged as shown in FIG. 4.

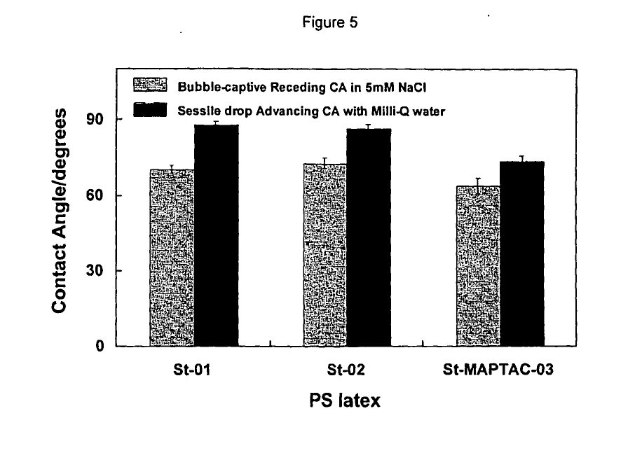

Both advancing and receding CA results of the three PS nanoparticle films are shown in FIG. 5. St-01 and St-02 were considered as pure PS (no comonomer) and their CA results were higher than St-MAPTAC-03, which has a higher content of hydrophilic groups. In general, advancing CA results were 10˜15 degrees higher than receding CA results. Three advancing CA results of St-01, St-02, and St-MAPTAC-03 were 88.3, 86.7, and 73.8 degrees, respectively. The three PS nanoparticles were considered relatively hydrophobic compared to the glass beads. The contact angle of clean glass is close to zero (Webb, K., Hlady, V., Tresco, P. A., Relative importance of surface wettability and charged functional groups on NIH 3T3 fibroblast attachment, spreading, and cytoskeletal organization. Journal of biomedical materials research 1998, 41, 422).

The flotation results of glass beads as a function of conditioning time are shown in FIG. 6. One measure of flotation efficiency is the initial slope of the curves in FIG. 6. Clearly polystyrene nanoparticle addition improved flotation efficiency (compare no PS curve to the others). Furthermore, the longer conditioning time gave better results, presumably because more hydrophobic nanoparticles deposited onto the hydrophilic beads with at longer times.

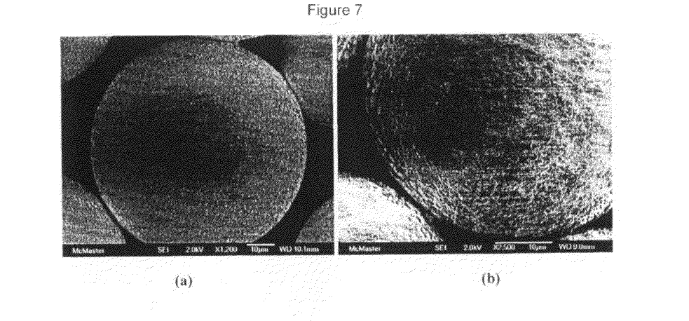

FIG. 7 shows the SEM images of samples taken from flotation mixtures (excess St-01-357 nm nanoparticle addition amount) at 5 min and 30 min conditioning intervals. Although time (2˜3 hours) was required to allow the samples to naturally desiccate before performing SEM techniques, the two contrastive images still can show the coverage differences between the two conditioning intervals. A 30 min conditioning time lead to more dense PS particles deposition onto glass beads (FIG. 7 (a)) than 5 min conditioning (FIG. 7 (b)). Simply put, a longer conditioning time lead to higher PS coverage ratio, which results in higher recovery of glass beads.

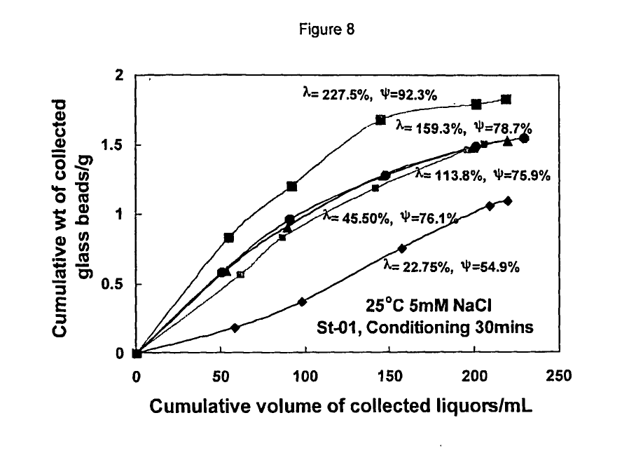

FIG. 8 shows the influence of PS nanoparticle concentration on flotation. The higher the initial PS concentration, the higher the flotation efficiency, presumably because more hydrophobic particles have deposited onto the glass beads.

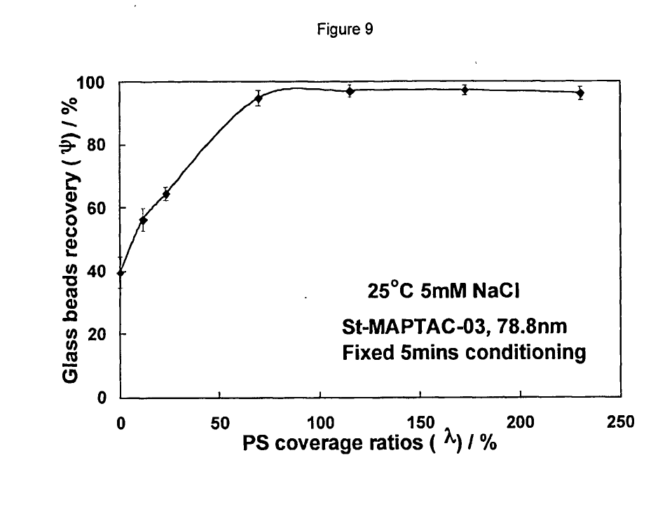

FIG. 9 shows the flotation recovery of glass beads as a function of fixed PS nanoparticle coverage ratios. Herein, the nanoparticles used were St-MAPTAC-03, 78.8 nm, which are relatively small, and will be effective in the filtration method to set particular PS coverage ratios, namely, excess PS nanoparticles can be isolated by filter paper from the glass beads covered by interacted St-MAPTAC-03. In general, the higher coverage ratio will give the higher recovery. When the addition amount is 0.5, 0.75, and 1 mL of 18.55 g/L St-MAPTAC-03, the calculated λ is 115%, 173%, and 230% respectively. For this fixed PS coverage ratios flotation experiments, they actually can be considered 100%. When the coverage ratio is 69%, 0.3 mL of 18.55 g/L St-MAPTAC-03, the recovery obtained is almost 95%. This indicates that to get relatively high flotation recovery (>95%), the 100% coverage ratio is not necessary. The calculation for the PS coverage ratios were shown in a separate Mathcad file.

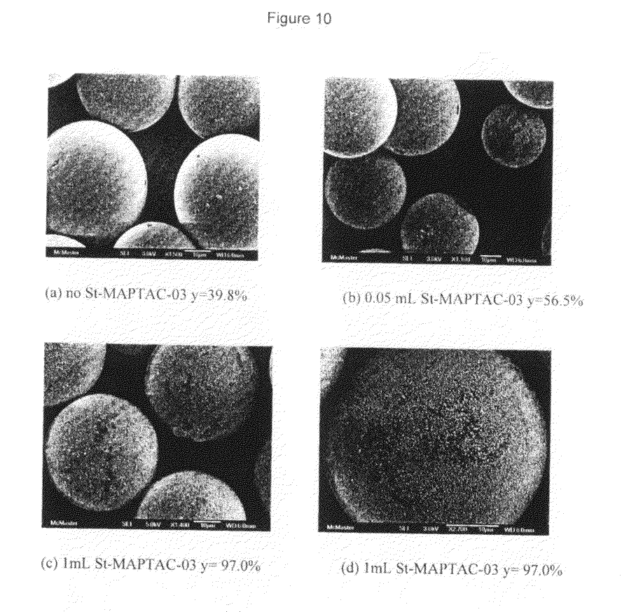

SEM images can directly indicate that the higher PS coverage ratios lead to higher glass beads recovery as shown in FIG. 10. The samples were taken after flotation

[symbol]

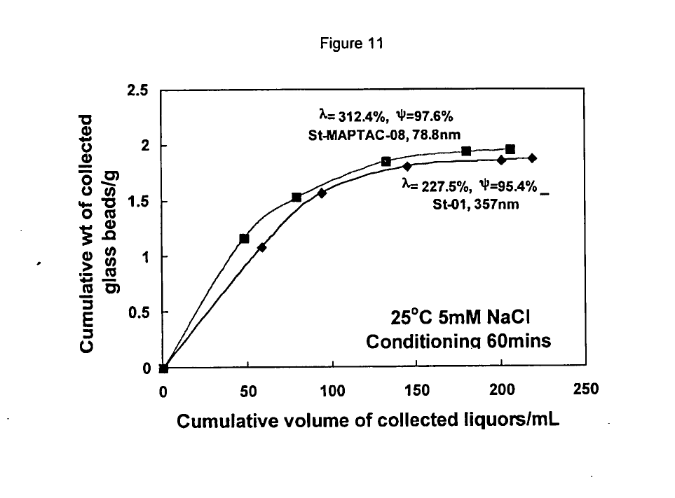

FIG. 11 compares the flotation performance of two types of nanoparticles differing by about a factor of five in diameter. The smaller ones are slightly more effective, possibly reflecting their higher number concentration when compared at the same mass concentration. Flotation recovery does not seem to be sensitive to latex particle diameter over the range (78˜353 nm) when conditioning 60 minutes.

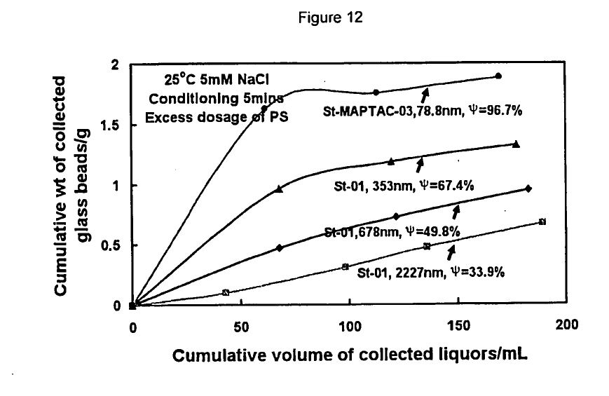

However, PS latex particle size has significant effect on glass bead recovery when conditioning for a short time (i.e. 5 mins). The higher diameter, the lower recovery (FIG. 12).

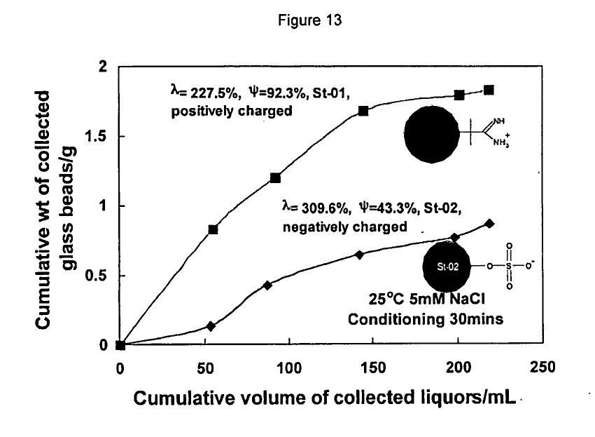

FIG. 13 shows that positively charged nanoparticles improved glass bead flotation whereas anionic nanoparticles had little effect. In these experiments, electrostatic attraction between oppositely charged beads and nanoparticles was relied on to drive adsorption. Thus the results in FIG. 13 were expected. However, electrostatic driven deposition is not a perquisite. Any interaction driving hydrophobic nanoparticle deposition such as antibody-antigen, complexation interactions, cis diol-borate, click chemistry etc. could be used to direct nanoparticle deposition on specific types of surfaces.

### Example 3

### Functionalized Nanoparticle Preparation And Characterization

Nanoparticle suspensions based on poly(styrene-co-vinylimidazole-co-MAPTAC), herein designated “St-VI-MAPTAC”, and poly(styrene-co-MAPTAC), designated “St-MAPTAC”, were prepared in by a monomer-starved, semibatch, surfactant-free emulsion polymerization. The recipes are summarized in Table 3. The polymerizations were conducted in a three-necked flask equipped with a condenser, two rubber stoppers holding syringe needles (one for monomer addition the other for nitrogen), and a magnetic stirring bar. 100 mL of Milli-Q water was charged to the reactor followed by nitrogen purging for 30 minutes at 70° C. with 350 rpm stirring. To the reactor were added 0.5 g styrene, 0.25 g of 50 wt. % MAPTAC, and 60 mg Vazo 50 initiator. After 15 minutes polymerization, an additional 4.5 g of styrene and 0.125 g of vinyl imidazole, dissolved in 4.8 mL water, were added over 5 hours from twin 10 mL syringes fitted to a syringe pump. The reaction was stirred at temperature for an additional 19 hours. The resulting latex was dialyzed for at least 3 days against Milli-Q water.

The hydrodynamic diameters of the nanoparticles were determined by dynamic light scattering (Brookhaven Instruments Corp.) using a detector angle of 90°. The CONTIN model was used to calculate the particle size distributions. Samples for both dynamic light scattering and electrophoretic mobility measurements were prepared in clean vials by dispersing roughly 0.25 g/L of PS nanoparticles in 5×10⁻³ M NaCl. Sample pH values were adjusted by using 0.1 M HCl and NaOH.

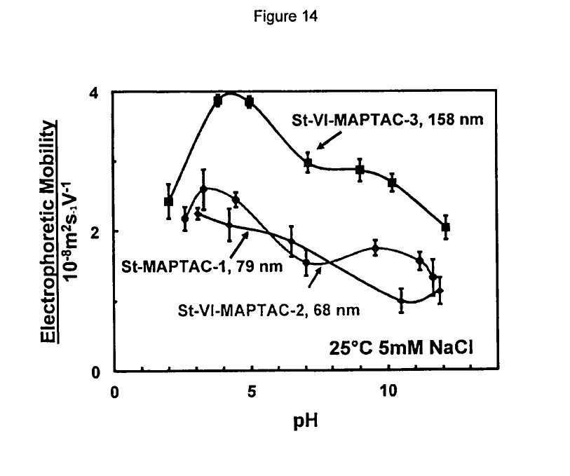

FIG. 14 shows the electrophoretic mobility of prepared St-VI-MAPTAC/St-MAPTAC nanoparticles as a function of pH. All three nanoparticles are positively charged because of the presence of amidine groups from the initiator¹ and because of the quaternary nitrogen on the MAPTAC moieties. In addition, the imidazole groups contribute cationic charge to VI nanoparticles. The complex pH behaviors shown in FIG. 14 reflect the pH sensitivity of the amidine (pKa=12.4¹) and the imidazole (pKa=6²) groups.

Advancing water contact angles were used as an indication of the hydrophobicity of the nanoparticles. Suspensions of cleaned nanoparticles were freeze-dried and pressed 10,000 psi by a Carver® hydraulic press at room temperature with a stainless steel mold used to prepare KBr pellets for infrared (IR) spectoscopy. The measurements were made with a Kruss DSA running DSA 1.80.0.2 software. The water drop volumes were 40˜50 μL and the results, summarized in Table 4, were the average of three measurements. All of the nanoparticles were hydrophobic reflecting the nature of polystyrene.

### Example 4

### Mineral And Slime Suspensions

This example describes the preparation and properties of three model suspensions: Pentlandite (Pn); glass beads—a model for unwanted negatively charged particles including silicates; and, Tails—MgO-rich slime materials from a commercial Pn process stream.

(a) Pentlandite and Tails cleaning procedure: 5 g Pn (or Tails) and 50 mL of deoxygenated 0.1 M HCl were charged into a three-necked 100 mL flask equipped with a sealable condenser, a rubber stopper with needle for N₂ purging, and a magnetic stirring bar. The mixtures were mixed for 1 h followed by settling and decanting the supernatant. The sediment was rinsed with 50˜80 mL deoxygenated water a couple of times. The wash water was removed by decantation and 50 mL of deoxygenated 0.5 M Na₂S.9H₂O solution was added and the suspension was mixed at room temperature for 5 h. After rinsing and decantation with 2×50˜80 mL deoxygenated water. The suspensions were diluted with deoxygenated water to give 0.1 g/mL suspensions used for flotation.

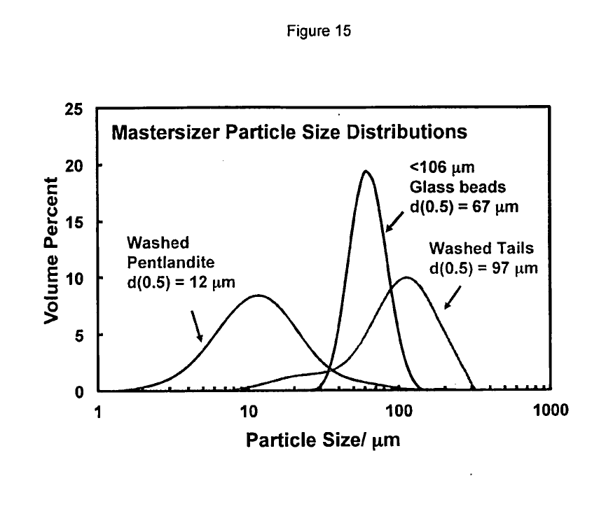

(b) Suspension Properties: The particle size distributions were measured with a Malvern Mastersizer 2000. The reported size distributions were the average of three repeated measurements for each suspension. The glass beads suspension was prepared by adding dry beads into 5×10⁻³ M NaCl until its obscuration level was within the required apparatus obscuration range. Suspensions of Pn and tails were measured by diluting each washed samples with 5×10⁻³ M Na₂CO₃ until the obscuration levels were in the range. The volume-weight particle size distributions for the three suspensions are shown in FIG. 15. The volume-weighted medium particle diameters (d(0.5)) are given in Table 5 and in FIG. 15. The particle size distributions of the glass beads and the Pn suspensions appeared log normal whereas the Tails distribution was asymmetric with a significant lobe at the low end of the distribution.

The mean particle diameters were used to estimate the specific surfaces areas of the three suspensions and the results are summarized in Table 5. The estimates were made assuming non-porous spherical particles.

Electrophoretic mobility measurements for the Pn and tails suspensions were performed by a Zeta PALS instrument (Brookhaven Instruments Corp.) at 25° C. in phase analysis light scattering mode. The Pn (or tails) sample was prepared in clean vials by dispersing 0.4 mL of roughly 0.1 g/mL washed suspension supernatant, consisting of Pn (or tails) with relatively small particle size, into 10 mL of 5×10⁻³ M NaCl. The reported mobility values for glass beads were the average of five runs with each consisting of 10 scans. For each single run, the testing cuvette charged with glass beads suspension in 5×10⁻³ M NaCl were shaken (mixed) and immediately placed into the sample chamber. The run was then at once commenced. Each single run required roughly 30 seconds to complete. After completing a single run, the cuvette was taken out, mixed and then reinserted into the chamber to start a second run. The reported EM values were the average of 10 runs with each consisting of 15 scans.

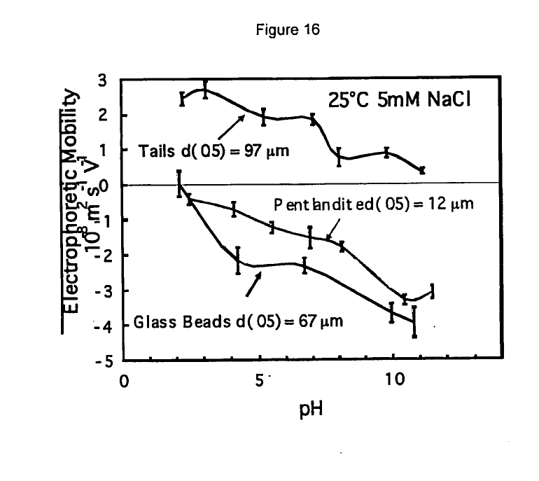

The electrophoretic mobilities of the Pn, glass beads and Tails suspensions are shown as functions of pH in FIG. 16. At natural pH, 5×10⁻³ M NaCl (pH=6.7±0.4), the pentlandite and glass beads were negatively charged with a mobility of about −1.5 and −2.3 10⁻⁸m²s⁻¹V⁻¹ respectively, while tails were positively charged with a mobility of roughly 1.8 10⁻⁸m²s⁻¹V⁻¹. Under the conditions of the small-scale flotation experiments for mixtures of Pn and Tails (5×10⁻³ M Na₂CO₃, pH=10.6±0.3), the mobility for negatively charged pentlandite was increased to −3.3, while the positively charged tails decreased to less than 0.5.

### Example 5

### Nickel Ion Binding To Nanoparticles

Binding isotherms for Ni²⁺ ions to the nanoparticles were measured as follows. Nickel ion solutions were prepared by dissolving NiSO₄ in water to give a series of concentrations (5×10⁻⁴ M, 1×10⁻³ M, 2×10⁻³ M and 3×10⁻³ M, corresponding to 29.4, 58.7, 117.4, and 176.1 ppm, respectively, of nickel). 0.5 mL of 33.3 g/L of St-VI-MAPTAC-3 was dispersed into 40 mL of the prepared Ni²⁺ solutions by ultrasonication for 2 minutes and followed by conditioning for 30 minutes at 25° C. The nanoparticle phase was then separated by centrifugation at 20,000 rpm for 30 min. The supernatant was collected and sufficient 70% HNO₃ was added to dissolve the nickel. The equilibrium Ni ion concentration in the supernatant was measured by the ICP-OES (Vista-Pro Type, Varian Inc.). The quantity of Ni²⁺ bound to the nanoparticles was determined from the difference of the initial and equilibrium Ni²⁺ concentrations.

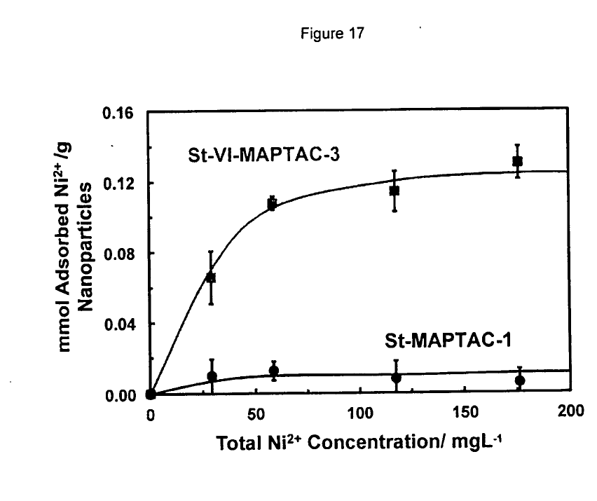

The binding of Ni²⁺ to the nanoparticles is shown in FIG. 17 for particles with (St-VI-MAPTAC-3) and without (St-MAPTAC-1) imidazole groups. St-MAPTAC-1 nanoparticles adsorbed very little Ni²⁺ (˜0.01mmol/g) whereas St-VI-MAPTAC-3 adsorbed about 0.12 mmol/g.

### Example 6

### Flotation Clean Pn Suspensions

All flotation experiments were performed in a custom lab-scale flotation apparatus (see FIG. 1). In a typical Pn flotation experiment 10 mL of 0.1 g/mL washed Pn suspension (or mixture of 10 mL 0.1 g/mL Pn and 1.0 g glass beads, or mixture of 10 mL of 0.15 g/mL Pn and 10 mL of 0.15 g/mL tails) and 0.5 mL of functional nanoparticles (24.2 g/L for St-VI-MAPTAC-2) were added into 110 mL of 5 mM NaCl (or 5×10⁻³ M Na₂CO₃) in a 150 mL plastic flotation beaker. The suspension of Pn and nanoparticles was mixed (conditioned) for 5 minutes to permit the nanoparticles to deposit onto the surface of Pn. Following conditioning UNIFROTH 250C (10 ppm) was added and mixed for 30 additional seconds. The nitrogen flow was started at a rate of 2.0 L/min through a Corning Pyrex™ gas dispersion tube with a 30 mm coarse glass frit attached by a 90-degree elbow. The foam phase was scraped over the edge of the beaker and captured in the plastic Petri dish. After 1.5 minutes, the gas flow was stopped, the plastic collection dish was replaced with a clean dish and the liquid level in the flotation beaker was topped up with UNIFROTH 250C in 5 mM NaCl. This sequence was repeated until 3 or 4 dishes were collected.

The mass of “accepts” collected in each dish was weighed and the solids were filtered and weighed. For flotation of mixed suspension (Pn+ glass beads or Pn+ Tails), the nickel content of the accepts was measured by ICP-OES.

The dosage of nanoparticles collectors was expressed as λ_{T}, which is equal to:

$$\frac{total projected area of the added nanoparticles}{total surface area of pentlandite}$$

For all of flotation results herein involving nanoparticle addition λ_{T} was greater than 100% meaning the nanoparticles were present in excess.

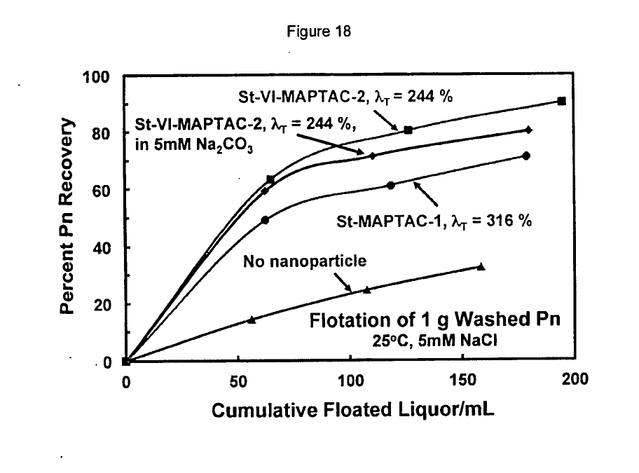

FIG. 18 shows the flotation recovery of washed pentlandite with use of St-MAPTAC-1 or St-VI-MAPTAC-2 nanoparticles. Clearly, the addition of either nanoparticle facilitated flotation recovery of Pn in comparison to the control. Without nanoparticles, only about 32% Pn was recovered by hydraulic entrainment, whereas higher recoveries were obtained in the presence of the two nanoparticles, 71% by St-MAPTAC-1 and 90% by St-VI-MAPTAC-2. The ligand functionalized St-VI-MAPTAC-2 were significantly better and the simple cationic particles, St-MAPTAC-1 in spite of the fact the imidazole functionalized particles were less hydrophobic according to the contact angle measurements (see Table 4).

In summary, this example illustrates that the cationic polystyrene nanoparticles are effective flotation collectors for Pn and that the imidazole functionalized particles perform better than simple cationic particles.

### Example 7

### Flotation of Pn− Glass Bead Mixtures

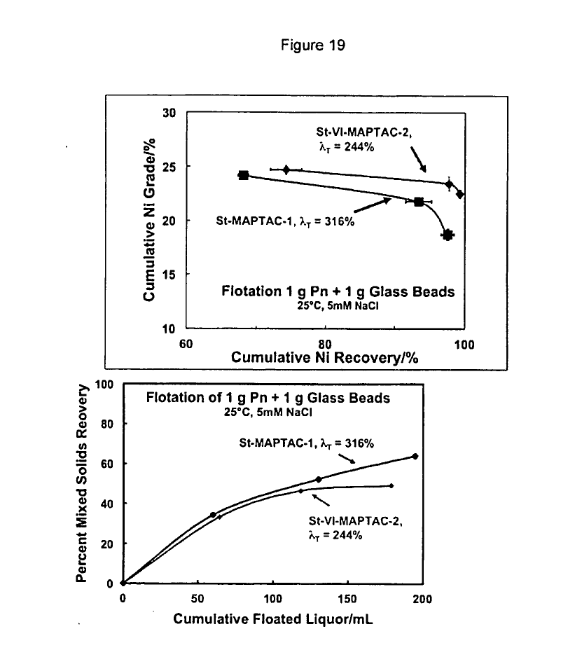

The goal of this example was to illustrate that nanoparticles with imidazole (VI) surface ligands preferentially bind to Pn in the presence of glass beads. Note that both the beads and Pn particles are negatively charged. Therefore electrostatics alone provides no selectivity. The flotation results are summarized in FIG. 19 that shows both the total solids recovery versus the volume of recovered liquid and cumulative Ni grade versus the cumulative Ni recovery. The three data points in each graph correspond to three dishes collected during the flotation run.

It is clear from the results summarized in FIG. 19 that St-VI-MAPTAC-2, the imidazole functionalized nanoparticles, gave a better Ni separation both in terms of Ni recovery and Ni grade.

### Example 8

### Flotation of Pn− Tails Mixed Suspensions

The utility of functionalized nanoparticle collectors in nickel ore flotation was demonstrated by flotation of mixtures of Tails (slime) with a clean pentlandite suspension using 33.3 mg Sr-VI-MAPTAC3 nanoparticles and was compared with using 0.12 mL of 1% potassium amyl xanthate of potassium amyl xanthate (PAX). The nickel/MgO grade (if mixed with tails) of samples collected from each small-scale flotation experiment were measured by an ICP analysis performed at Vale. Approximately 250 mg of sample was weighed into a zirconium crucible. 3.4 g of sodium peroxide and 2-3 pellets of sodium hydroxide were added to the sample and mixed. The crucible was placed into a muffle furnace at 710° C. for 35 minutes. The resulting cake was then leached with water and hydrochloric acid. The solution was diluted to a 250 mL volume and the composition was measured with a Varian Vista ICP-OES.

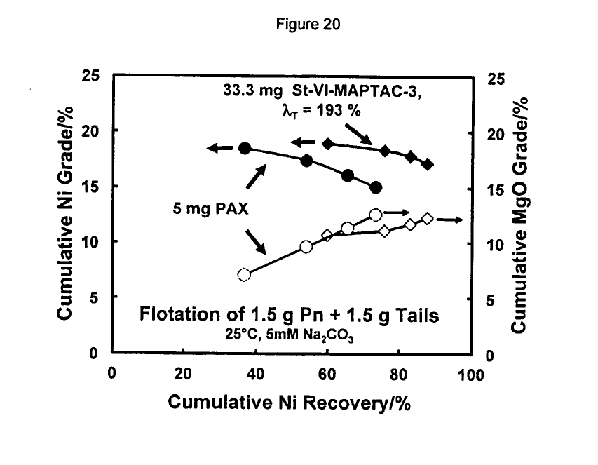

The results in FIG. 20 show cumulative Ni grade and cumulative MgO grade versus Ni recovery. Also shown are results for PAX. The VI functionalized nanoparticles give superior separation.

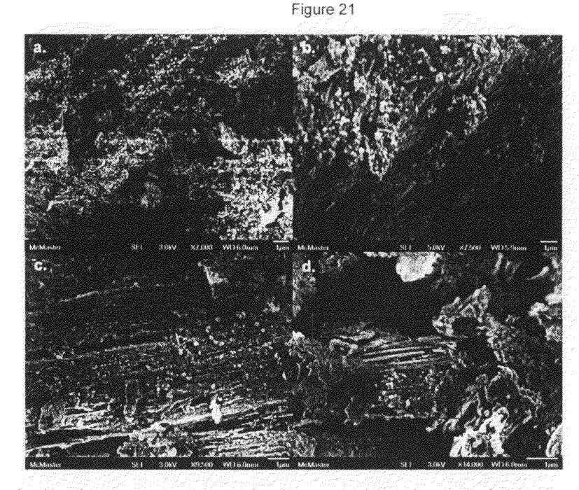

One of the advantages of the nanoparticle collectors is that they can be directly observed by a scanning electron microscope. FIG. 21 shows micrographs of the recovered Pn surfaces and Tails surfaces remaining in the flotation cell. A high coverage of nanoparticles is seen on the Pn surfaces whereas there are very few nanoparticles deposited on the slime surfaces.

### Example 9

### Flotation Experiments With Calcium Carbonate Particles

Materials: The commercial grades of precipitated calcium carbonates (PCC) were Socal 31 (Solvay), Ultra Pflex and Thixo-Carb HP (Specialty Minerals). The parameters of PCC samples are summarized in Table 6. Stearic acid with molecular weight of 284.48 and glass beads with 106 μm mean particle size were purchased from Sigma Aldrich. Reagent grade ethylenediaminetetraacetic acid (EDTA) was purchased from J.T. Baker. An acidic, aqueous dispersion of colloidal silica stabilized with aluminum oxide (Bindzil CAT 80) was prepared from AkzoNobel Co.

Treatment with stearic acid: The untreated commercial PCC samples were acid treated in the lab to be hydrophobic. In this method, a very thin monolayer of hydrophobic fatty acid is attached to the calcium carbonate surface and the acid group in fatty acid molecule forms a water insoluble calcium salt. Then, hydrophobic tail oriented to the air and the hydrophobic modified PCC is prepared with a fatty acid.

Furthermore, by increasing the concentration of fatty acid, the hydrophobicity of PCC increased, until the point where a double layer of fatty acid was formed (adsorbed) on the PCC resulting in the extra hydrophobic tails of fatty acid presenting toward the coating layer and the hydrophilic heads orienting to the water, leading to decreased hydrophobicity.

20 g (dry powder) of untreated PCC (Socal 31) and 0.1 g and 0.2 g stearic acid were mixed into 80 ml of distilled water at 75° C. and 800 rpm mixing rate for 30 minutes to provide 0.5% and 1%, respectively, stearic acid-treated PCC. The slurries were then dried in the oven (at 105° C. for 10 hours) and grinded.

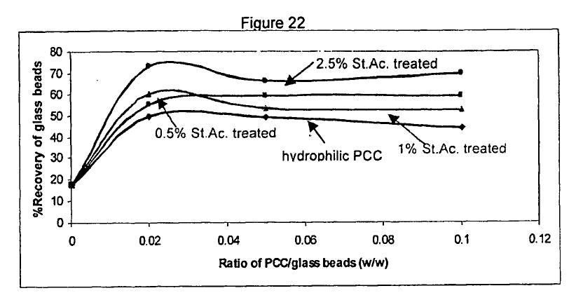

Flotation experiments with glass beads were done for all PCC samples and the results shown in FIG. 22. The control experiments with no particle show 18% recovery of glass beads.

It is clear from FIG. 22, that by increasing the percentage of PCC and increasing the hydrophobicity, flotation of glass beads increased. Also, it is clear that increasing the ratio of PCC to glass beads does not increase the flotation recovery, likely due to the larger size of the PCC.

TABLE 1
PS Nanoparticle Polymerization Recipes and the Properties of Prepared PS Nanoparticles for
Example 1

| | | | | | Hydrodynamic | |
|---|---|---|---|---|---|---|
| | | | | | Diameters | |
| PS | St | 50 wt % | Water | Initiators | nm | EM |
| Nanoparticle | monomer g | MAPTAC g | mL | mg | (Polydispersity) | 10⁻⁸ m²s⁻¹V⁻¹ |
| St-01 | 5 | 0 | 110 | 60-V-50 | 357 | 3.42 |
| | | | | | (0.097) | |
| St-02 | 5 | 0 | 110 | 200-APS | 280 | −5.91 |
| | | | | | (0.108) | |
| St-MAPTAC- | 5 | 0.5 | 110 | 60-V50 | 78.8 | 1.85 |
| 03 | | | | | (0.085) | |

TABLE 2
The Properties of Purchased Surfactant-free amidine White
Polystyrene Latex

| | Hydrodynamic | |
|---|---|---|
| Surfactant-free | Diameters | |
| amidine white | nm | EM |
| polystyrene latex | (Polydispersity) | 10⁻⁸ m²s⁻¹V⁻¹ |
| St-01-760 | 678 | 4.43 |
| | (0.126) | |
| St-01-2600 | 2227 | 2.08 |
| | (0.205) | |

TABLE 3
Recipes for Preparation of St-VI-MAPTAC/St-MAPTAC
Nanoparticles for Example 3

| | | | | | Starved-feed Charge | | |
|---|---|---|---|---|---|---|---|
| | Initial reactor charge (g) | | | | (g) | | |
| Designation | Water | St | MAPTAC | V50 | St | VI | MAPTAC |
| St-MAPTAC-1 | 250 | 0.5 | 0.125 | 0.06 | 4.5 | — | 0.125 |
| St-VI- | 100 | 0.5 | 0.25 | 0.06 | 4.5 | 0.125 | — |
| MAPTAC-2 | | | | | | | |
| St-VI- | 100 | 0.5 | 0.25 | 0.10 | 4.5 | 0.25 | — |
| MAPTAC-3 | | | | | | | |

TABLE 4
The Properties of St-VI-MAPTAC and St-MAPTAC Nanoparticles

| | | Advancing |
|---|---|---|
| | | water |
| | Hydrodynamic | contact |
| | diameter/nm | angle/degrees |
| Designation | (Polydispersity) | (Std. error) |
| St-MAPTAC-1 | 79 (0.085) | 78 (±4.5) |
| St-VI-MAPTAC-2 | 68 (0.159) | 71 (±3.8) |
| St-VI-MAPTAC-3 | 158 (0.033) | 66 (±2.9) |

TABLE 5
Properties of the Suspensions

| | | Mean Diameter | Specific Surface |
|---|---|---|---|
| | Density (g/ml) | (μm) | area (m²/g) |
| Pn | 4.8 | 12 | 0.104 |
| Glass beads | 2.45 | 67 | 0.037 |
| Tails | 2.7 (Serpentine) | 97 | 0.023 |

TABLE 6
Characteristics of Commercial PCCs

| | | | Stearic acid |
|---|---|---|---|
| | Specific surface | Average particle | content |
| Name | area (m²/g) | size (nm) | (%) |
| Socal 31 | 20 | 70 | 0 |
| Thixo-Carb HP | 28 | 60 | 2.5 |
| Ultra Pflex | 19 | 70 | 3 |

1. A process for collecting a particulate material from a mixture comprising treating the mixture with hydrophobic nanoparticles under conditions to adsorb the hydrophobic nanoparticles to the particulate material and collecting the particulate material by flotation.

2. The process of claim 1, wherein the hydrophobic nanoparticles comprise, consist of, or consist essentially of polymeric nanoparticles or inorganic nanoparticles.

3. The process of claim 2, wherein the polymeric nanoparticles are selected from nanoparticles prepared from polymers and co-polymers based on vinyl monomers, fluorochemical polymers and copolymers, and condensation polymers.

4.-7. (canceled)

8. The process of claim 2, wherein the hydrophobic nanoparticles comprise inorganic nanoparticles prepared from silica, calcium carbonate, aluminum silicates, aluminates or titanium dioxide.

9. (canceled)

10. The process of claim 8, wherein the inorganic nanoparticles are coated with a hydrophobic substance.

11. The process of claim 10, wherein the hydrophobic substance is a fatty acid.

12. The process of claim 1, wherein the hydrophobic nanoparticles comprise a means for adsorbing the nanoparticles to the particulate material.

13. The process of claim 12, wherein the means for adsorbing the nanoparticles to the particulate material is selected from, electrostatic interactions, antibody-antigen interactions, complexation, biotin-streptavidin interaction, and chemical bond formation between compatible functional groups, and combinations thereof.

14. The process of claim 13, wherein the chemical bond formation between compatible functional groups is selected from cis-diol borate coupling and azide-alkyne Huisgen cycloaddition.

15. The process of claim 13, wherein the means for adsorbing the nanoparticles to the particulate material comprises electrostatic interactions.

16. The process of claim 13, wherein the means for adsorbing the hydrophobic nanoparticles to the particulate material comprises complexation and the hydrophobic nanoparticles are modified to comprise a functional group that forms a complex with the particulate material.

17. The process of claim 16, wherein the functional groups are selected from carboxyl groups, sulfate groups, phosphate groups, primary amines, secondary amines, tertiary amines, quaternary amines, imidazole groups, oxime groups, histidine groups, thiourea group, hydroxyquinoline groups and xanathate groups, and combinations thereof.

18. The process of claim 1, wherein the hydrophobic nanoparticles have a diameter of about 10 nm to about 2000 nm, or about 50 nm to about 500 nm.

19. The process of claim 1, wherein the particulate material comprises, consists of, or consists essentially of, sulfide minerals, nonsulfide minerals, or precious metals.

20. The process of claim 1, wherein the mixture is a mineral ore or precious metal ore.

21. The process of claim 1, wherein the particulate material comprises nickel, copper, gold, platinum, palladium, bismuth, molybdenum, arsenic, uranium, lead, zinc, tin, iron, phosphates, potash, coal, silicates, sulfates, oxides or salts, or combinations thereof.

22. The process of claim 1, wherein the particulate material is selected from silicates, pentlandite, copper sulfides, chalcopyrite, chalcocite and malachite, and mixtures thereof.

23. (canceled)

24. The process of claim 1, wherein the conditions to adsorb the hydrophobic nanoparticles to the particulate material comprise combining a solution comprising the particulate material with a solution comprising the hydrophobic nanoparticles for a time sufficient for the nanoparticles to adsorb to the particulate material.

25. The process of claim 24, wherein the particulate material and the hydrophobic nanoparticles are combined in a neutral or basic solution.

26. The process of claim 1, further comprising the use of a molecule collector in combination with the hydrophobic nanoparticles.

27. (canceled)
